(19) United States
(12) Patent Application Publication
(10) Pub. No.: US 2011/0031361 A1
(43) Pub. Date: Feb. 10, 2011

(54) UTENSIL HOLDER

(76) Inventor: Edward D. Garvin, Boone, NC (US)

Correspondence Address: OLIVE LAW GROUP, PLLC, 130 EDINBURGH SOUTH DRIVE, SUITE 107, CARY, NC, 27511, US

(21) Appl. No.: 12/848,324

(22) Filed: Aug. 2, 2010

Related U.S. Application Data
(60) Provisional application No. 61/231,700, filed on Aug. 6, 2009.

(51) Int. Cl. F16M 13/02

(52) U.S. Cl. 248/213.2

(57) ABSTRACT

A utensil holder for holding a utensil proximal a cooking container is provided. The utensil holder includes an integrally formed structure that defines a longitudinal, container engaging recess. The holder further defines a first lateral, utensil engaging recess that has a first pair of longitudinally spaced-apart engaging surfaces configured to securely engage a first utensil having a first predetermined size and a second pair of longitudinally spaced-apart engaging surfaces configured to securely engage a second utensil having a second predetermined size different from the first predetermined size of the first utensil.

### PRIORITY CLAIM

This application claims priority to U.S. Provisional Patent Application No. 61/231,700 filed on Aug. 6, 2009, the contents of which are hereby incorporated by reference.

### BACKGROUND OF THE INVENTION

The present invention relates to holding household utensils and more particularly to attaching a hand-held household utensil to a container. While cooking foods and other liquids in a pot, spoons are used to stir the food or other liquid in order to keep the food from sticking or burning itself to the pot. In other instances, spoons may be used for mixing food within a container such as a serving dish. When the spoon is not in use, it is often laid down on the countertop or on a proximally positioned plate, napkin, or spoon rest. Sauces or food on the spoon then drip off onto the countertop or nearby structure and create a mess that must be cleaned up. This also represents a sanitary risk because bacteria and other contaminants are transferred from the countertop or nearby structure to the container on the spoon.

Sometimes, if the spoon is long enough, it can be leaned against the inside wall of the container having the sauce or liquid thereby eliminating the dripping onto the counter. The spoon in this situation, if metal, can become hot and uncomfortable to hold. The spoon may also be deep enough in the container to permit contact of the spoon handle with the contents of the container. Thus, the spoon handle becomes very messy and difficult to hold.

If the spoon is not long enough, which is quite often the case, it falls down into the sauce and must then be retrieved by yet another utensil causing further washing and needless frustration for the cook. Some utensils used for commercial cooking have a hook at the end of the handle to hold the utensil on the lip of a deep container. Again the handle may touch the container's side wall, and hence the contents of the container, causing the handle to become very messy and difficult to hold. While handles with hooked ends may be adequate for commercial purposes, most household utensils have no hooks. Clearly a better method for holding and retrieving a household hand-held utensil is needed.

Clips have been designed which are configured to clip onto the side of a container and hold the spoon or other food utensil. However, these clips suffer from various drawbacks including relatively high cost of manufacturing, the complexity and number of parts that require difficult cleaning, the relative instability of the utensil in the clip, any thermal heat transfer to the clip making the clip too hot to handle, and other aesthetic concerns. It is believed that current clips can only hold one utensil at a time and are not readily adjustable to fit various size utensils. Thus, the clips do not offer much in the way of versatility and/or usability. Still, other clips or utensil holders are not easily adapted to various size and styles of pots, pans, or other containers. For example, some pots have a straight circumferential edge, whereas others offer an outwardly facing flange. Other containers, such as those made by the Tupperware Brands Corporation® offer various style flanges and sealing means.

Accordingly, a need exists for a utensil holder that is versatile and usable with various styles of utensils and containers.

### SUMMARY OF THE INVENTION

It is an object of the invention to provide a utensil holder that is aesthetically pleasing.

It is another object of the invention to provide a utensil holder that is versatile and able to fit on a variety of container shapes and sizes.

It is another object of the invention to provide a utensil holder that is configured to hold a variety of differently shaped utensils.

It is another object of the invention to provide a utensil holder that is configured to hold multiple utensils at one time.

It is another object of the invention to provide a utensil holder that is thermally insulative. It is another object of the invention to provide a utensil holder with a minimum number of parts.

It is another object of the invention to provide a utensil holder that is cost effective to manufacture.

These and other objects of the present invention are achieved in preferred embodiments by providing a utensil holder for holding a utensil proximal a cooking container. The utensil holder includes an integrally formed structure that defines a longitudinal, container engaging recess. The holder further defines a first lateral, utensil engaging recess that has a first pair of longitudinally spaced-apart engaging surfaces configured to securely engage a first utensil having a first predetermined size and a second pair of longitudinally spaced-apart engaging surfaces configured to securely engage a second utensil having a second predetermined size different from the first predetermined size of the first utensil.

According to another embodiment of the present invention, the second pair of longitudinally spaced-apart surfaces are interconnected by an arcuate surface.

According to another embodiment of the present invention, the first pair of longitudinally spaced-apart engaging surfaces and the second pair of longitudinally spaced-apart engaging surfaces are interconnected.

According to another embodiment of the present invention, the distance between each of the first pair of longitudinally spaced-apart engaging surfaces is greater than the distance between each of the second pair of longitudinally spaced-apart engaging surfaces.

According to another embodiment of the present invention, the holder further defines a second lateral, utensil engaging recess that has a first slot configured to securely engage a third utensil having a third predetermined size and a second slot configured to securely engage a fourth utensil having a fourth predetermined size different from the third predetermined size of the third utensil.

According to another embodiment of the present invention, the container engaging recess defines a first longitudinally extending slot for receiving a container having a generally straight longitudinally extending surface.

According to another embodiment of the present invention, the container engaging recess defines a first laterally extending slot for receiving a container having an outwardly facing flange.

According to another embodiment of the present invention, the container engaging recess defines a first longitudinally extending slot for receiving a container having a generally straight longitudinal surface.

According to another embodiment of the present invention, the container engaging recess further defines two opposing surfaces moveable between a first position in which the two opposing surfaces form an interface and a second position in which at least one of the two opposing surfaces is deformable to form a clearance for allowing insertion of the container.

According to another embodiment of the present invention, a utensil holder for holding a utensil proximal a cooking container is provided. The utensil holder includes an integrally formed structure that defines a longitudinal, container engaging recess, a first lateral, utensil engaging recess that has a first pair of longitudinally spaced-apart engaging surfaces configured to securely engage a first utensil having a first predetermined size and a second pair of longitudinally spaced-apart engaging surfaces configured to securely engage a second utensil having a second predetermined size different from the first predetermined size of the first utensil, and a second lateral, utensil engaging recess that has a first slot configured to securely engage a third utensil having a third predetermined size and a second slot configured to securely engage a fourth utensil having a fourth predetermined size different from the third predetermined size of the third utensil.

A utensil holder for holding utensils proximal a container of the type having a longitudinally extending sidewall is provided. The holder includes a first laterally extending, utensil engaging recess configured to engage a first and a second utensil having respective first and second predetermined diameters, a second laterally extending, utensil engaging recess configured to engage a third and a fourth utensil having respective third and fourth predetermined diameters, and a longitudinally extending slot defined by opposing surfaces and configured for engaging the sidewall of the container moveable between a first position in which the two opposing surfaces are closely positioned to form an interface and a second position in which at least one of the two opposing surfaces is deformable to form a clearance for allowing insertion of the container

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1A is a front-facing perspective view of the utensil holder according to the present invention;

FIG. 1B is a rear-facing perspective view of the utensil holder according to the present invention;

FIG. 2A is a front view of the utensil holder according to the present invention;

FIG. 2B is a view of FIG. 2A showing dimensions of one embodiment of the utensil holder according to the present invention;

FIG. 3A is a rear view of the utensil holder according to the present invention;

FIG. 3B is a view of FIG. 3A showing dimensions of one embodiment of the utensil holder according to the present invention;

FIG. 4A is a side view of the utensil holder according to the present invention;

FIG. 4B is a view of FIG. 4A showing dimensions of one embodiment of the utensil holder according to the present invention;

FIG. 5A is a bottom view of the utensil holder according to the present invention;

FIG. 5B is a view of FIG. 5A showing dimensions of the utensil holder according to the present invention;

FIG. 6 is a top view of the utensil holder according to the present invention;

FIG. 7 is a cross-sectional view of the utensil holder installed on a container of the type having a straight side; and

FIG. 8 is a cross-sectional view of the utensil holder installed on a container of the type having an outwardly facing flange.

### DESCRIPTION OF THE PREFERRED EMBODIMENTS AND BEST MODE

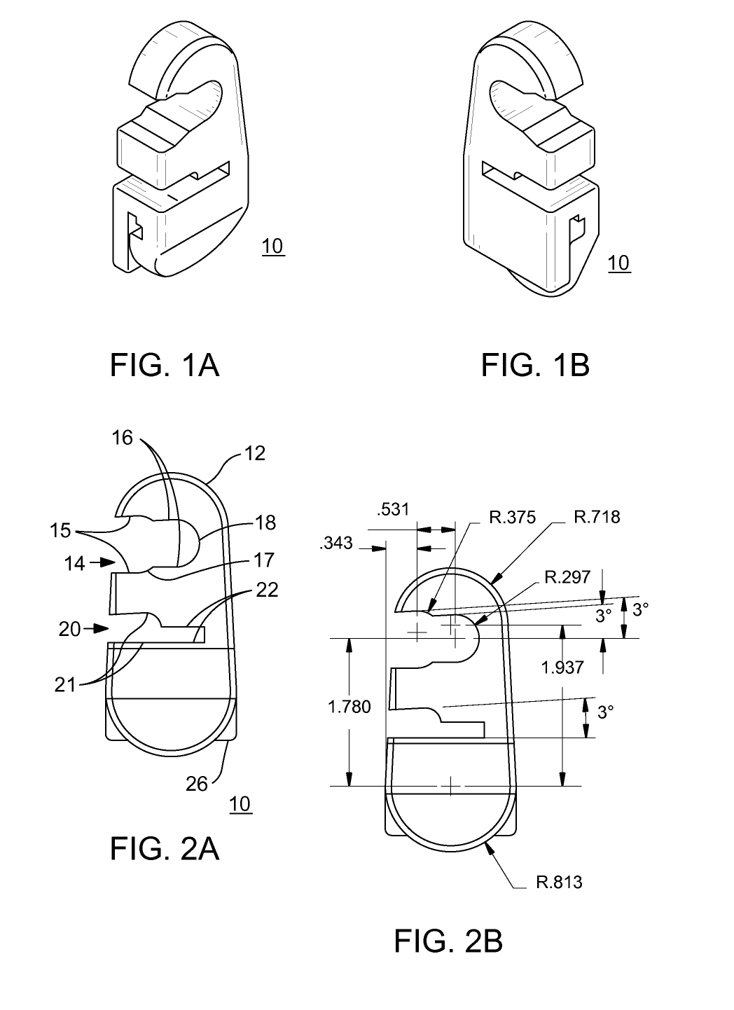

Referring now specifically to the drawings, a utensil holder is shown throughout the Figures and is generally designated 10. As shown in FIGS. 1A and 1B, the utensil holder 10 has an aesthetically pleasing design. The utensil holder 10 may be made of a one-piece design and may be preferably made from a Food and Drug Administration (“FDA”) grade silicone material. This material may be molded to form the utensil holder 10. It is envisioned that the utensil holder will be available in many colors, and may also be heat resistant, dishwasher safe, and designed to provide easy stowage.

As shown in FIG. 2A, the utensil holder 10 includes a base structure 12 that defines a first lateral, utensil engaging recess 14 having a first pair of longitudinally spaced-apart, utensil engaging surfaces 15 and a second pair of longitudinally spaced-apart, utensil engaging surfaces 16. Surfaces 15 are preferably for holding utensils or tools having a handle diameter between ⅝ and one inch with either a generally round or generally square shape. Surfaces 16 are preferably for holding utensils or tools having a diameter between ⅜ and ⅝ of an inch with either a generally round or generally square shape. Surfaces 15 and 16 are interconnected by arcuate surface 17. An arcuate surface 18 also interconnects surfaces 16. The utensil holder 10 may also define a second lateral, utensil engaging recess 20 that has a first generally flat pair of horizontal, utility engaging surfaces 21 that form a first engaging slot and a second generally flat pair of horizontal, utility engaging surfaces 22 that form a second engaging slot. Surfaces 21 are preferably for holding utensils or tools having handle thickness between 3/16 and ⅜ of an inch with preferably a generally square or generally rectangular shaped handle. Surfaces 22 are preferably for holding utensils or tools having handle thickness between 3/32 and 3/16 of an inch with preferably a generally square or generally rectangular shaped handle. FIG. 2B represents various dimensions of the utensil holder 10 shown in FIG. 2A in an embodiment of the present invention.

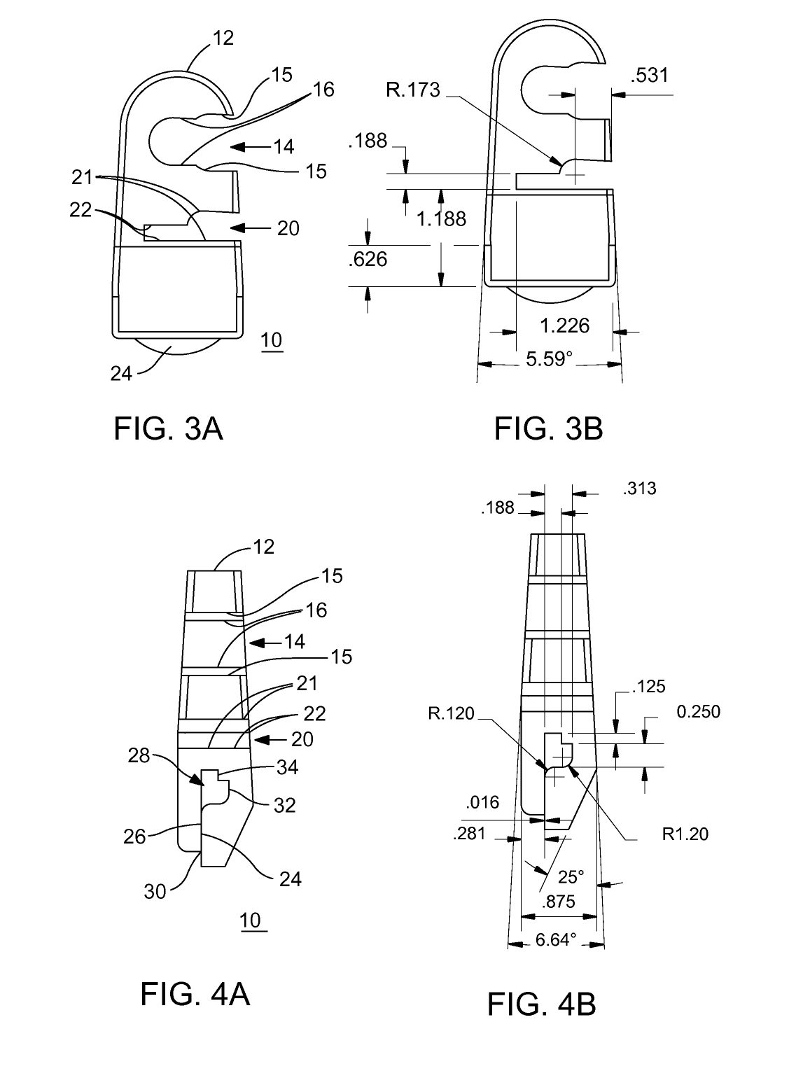

FIG. 3A represents the utensil holder shown in FIGS. 1A, 1B, 2A, and 2B, with the utensil holder being shown in a reversed orientation relative to FIGS. 2A and 2B. With regard to the remaining Figures, like referenced elements are represented by like referenced numbers.

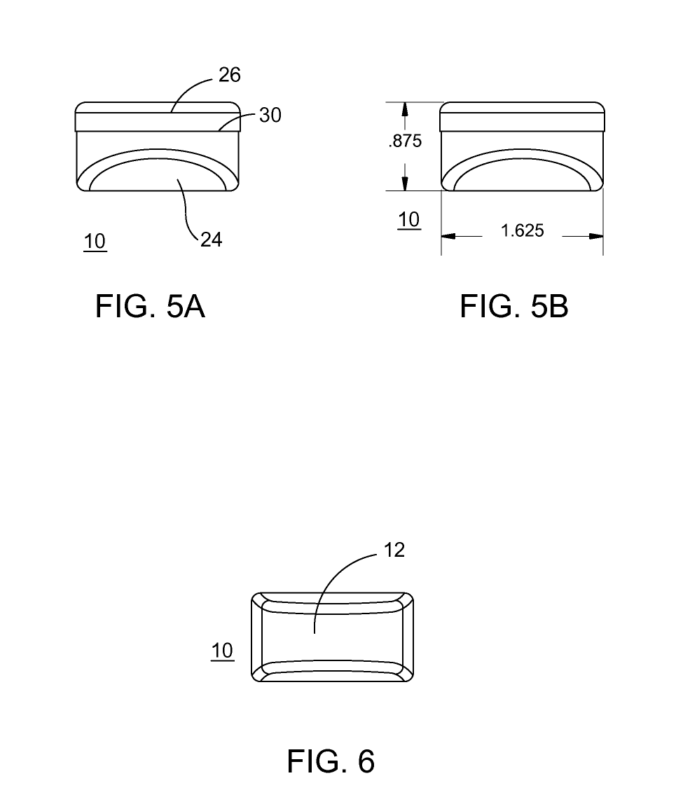

As shown in FIGS. 4A and 4B, the utensil holder 10 defines a first container engaging, longitudinal recess 28 for receiving a generally vertically oriented side of a container. The longitudinal recess 28 includes an “L” shaped notch defined by a respective pair of slots labeled with element numbers 32, 34 that are in contact with and extend into the intersection 30 formed between a first mating surface 24 and a second mating surface 26. These mating surfaces 24, 26 are provided to form an interference type fit with the side of the container. The mating surfaces 24, 26 have a generally flexible nature such that they can be pulled back, thereby opening up a gap formed at intersection 30 for receiving the side of the container. FIGS. 5A, 5B, and 6 represent various additional views of the utensil holder 10, as well as various dimensions of one embodiment of the present invention.

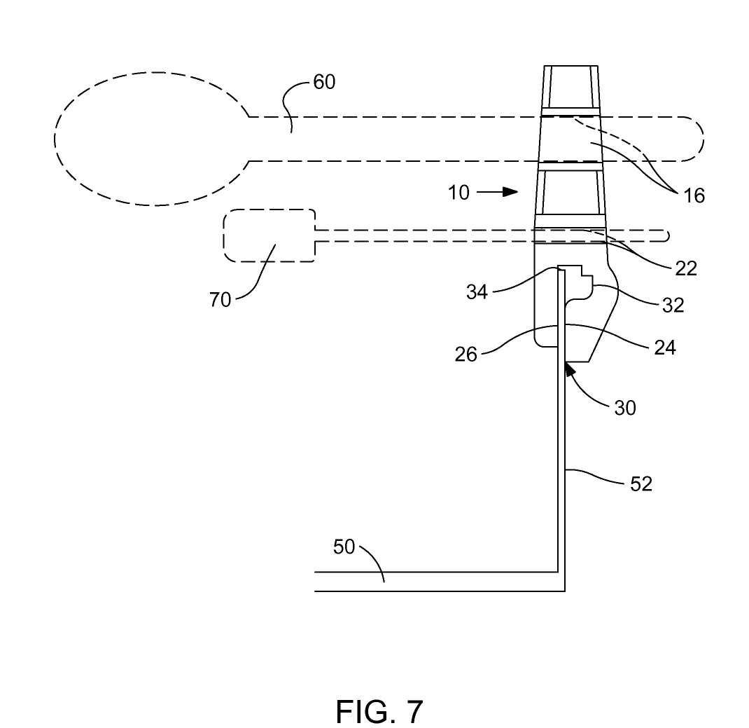

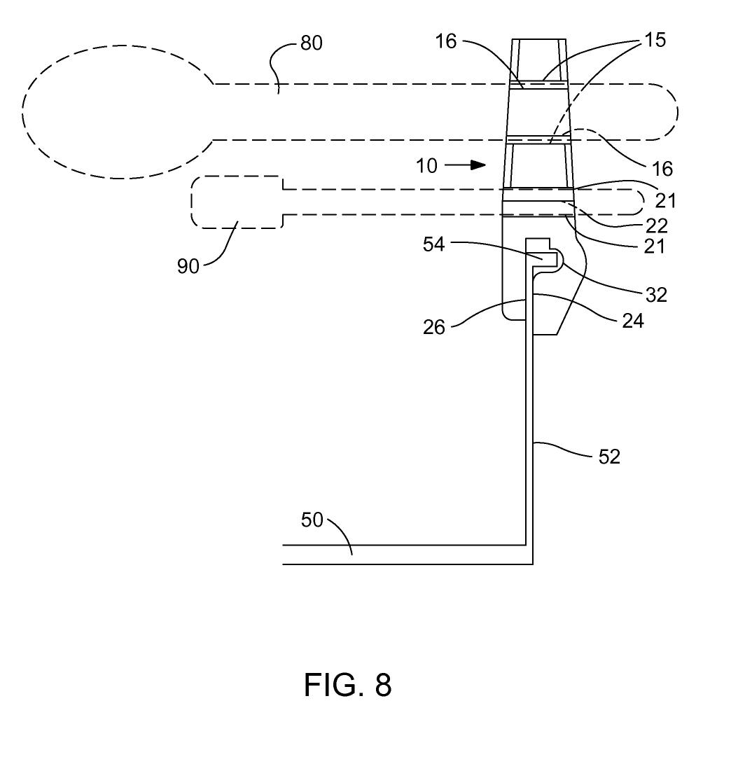

Operation and use of the utensil holder 10 is shown in FIGS. 7 and 8. As shown in FIG. 7, a container 50 having a generally straight vertical side 52 is shown along a cross-sectional view of the container. The utensil holder 10 is slid down onto the side 52 at the intersection 30 formed between mating surfaces 24 and 26. In this view, the generally straight vertical side 52 extends into recess 34. Also as shown in FIG. 7, various utensils 60 and 70 are shown installed on the utensil holder 10. Utensil 60 is inserted and fits within surfaces 16 and utensil 70 is inserted and fits within the slot formed from surfaces 22. The utensils 60, 70 are shown as being suspended in a generally horizontal position relative to the utensil holder 10, however, the utensil holder 10 may be made more flexible such that the utensils 60, 70 will have a generally declined position towards the container 50.

As shown in FIG. 8, the utensil holder 10 is shown mounted on a container 50 having a vertical side 52 and an outwardly facing flange 54. In this embodiment, the utensil holder 10 is slid down onto the side 52 at the intersection 30 formed between mating surfaces 24 and 26, just as described with reference to FIG. 7. In this view, the outwardly facing flange 54 extends into recess 32. Also as shown in FIG. 8, various utensils 80 and 90 are shown installed on the utensil holder 10. Utensil 80 is inserted and fits within surfaces 15 and utensil 90 is inserted and fits within surfaces 21.

It is understood that the configuration of container 50 as shown in FIGS. 7 and 8 is for representative purposes only and does not restrict the inventive concept of the utensil holder 10. In other embodiments, containers having different shapes and configurations may be employed.

A utensil holder is described above. Various details of the invention may be changed without departing from its scope. Furthermore, the foregoing description of the preferred embodiment of the invention and the best mode of practicing the invention are provided for the purpose of illustration only and not for the purpose of limitation.

1. A utensil holder for holding a utensil proximal a cooking container, comprising:
an integrally formed structure that defines a longitudinal, container engaging recess, and that further defines a first lateral, utensil engaging recess that has a first pair of longitudinally spaced-apart engaging surfaces configured to securely engage a first utensil having a first predetermined size and a second pair of longitudinally spaced-apart engaging surfaces configured to securely engage a second utensil having a second predetermined size different from the first predetermined size of the first utensil.

2. The utensil holder according to claim 1, wherein the second pair of longitudinally spaced-apart surfaces are interconnected by an arcuate surface.

3. The utensil holder according to claim 1, wherein the first pair of longitudinally spaced-apart engaging surfaces and the second pair of longitudinally spaced-apart engaging surfaces are interconnected.

4. The utensil holder according to claim 3, wherein the distance between each of the first pair of longitudinally spaced-apart engaging surfaces is greater than the distance between each of the second pair of longitudinally spaced-apart engaging surfaces.

5. The utensil holder according to claim 1, further including a second lateral, utensil engaging recess that has a first slot configured to securely engage a third utensil having a third predetermined size and a second slot configured to securely engage a fourth utensil having a fourth predetermined size different from the third predetermined size of the third utensil.

6. The utensil holder according to claim 1, wherein the container engaging recess defines a first longitudinally extending slot for receiving a container having a generally straight longitudinally extending surface.

7. The utensil holder according to claim 1, wherein the container engaging recess defines a first laterally extending slot for receiving a container having an outwardly facing flange.

8. The utensil holder according to claim 7, wherein the container engaging recess defines a first longitudinally extending slot for receiving a container having a generally straight longitudinal surface.

9. The utensil holder according to claim 8, wherein the container engaging recess further defines two opposing surfaces moveable between a first position in which the two opposing surfaces form an interface and a second position in which at least one of the two opposing surfaces is deformable to form a clearance for allowing insertion of the container.

10. A utensil holder for holding a utensil proximal a cooking container, comprising:
an integrally formed structure that defines a longitudinal, container engaging recess, a first lateral, utensil engaging recess that has a first pair of longitudinally spaced-apart engaging surfaces configured to securely engage a first utensil having a first predetermined size and a second pair of longitudinally spaced-apart engaging surfaces configured to securely engage a second utensil having a second predetermined size different from the first predetermined size of the first utensil, and a second lateral, utensil engaging recess that has a first slot configured to securely engage a third utensil having a third predetermined size and a second slot configured to securely engage a fourth utensil having a fourth predetermined size different from the third predetermined size of the third utensil.

11. The utensil holder according to claim 10, wherein the second pair of longitudinally spaced-apart surfaces are interconnected by an arcuate surface.

12. The utensil holder according to claim 10, wherein the first pair of longitudinally spaced-apart engaging surfaces and the second pair of longitudinally spaced-apart engaging surfaces are interconnected.

13. The utensil holder according to claim 12, wherein the distance between each of the first pair of longitudinally spaced-apart engaging surfaces is greater than the distance between each of the second pair of longitudinally spaced-apart engaging surfaces.

14. The utensil holder according to claim 10, wherein the container engaging recess defines a first longitudinally extending slot for receiving a container having a generally straight longitudinally extending surface.

15. The utensil holder according to claim 10, wherein the container engaging recess defines a first laterally extending slot for receiving a container having an outwardly facing flange.

16. The utensil holder according to claim 15, wherein the container engaging recess defines a first longitudinally extending slot for receiving a container having a generally straight longitudinal surface.

17. The utensil holder according to claim 16, wherein the container engaging recess further defines two opposing surfaces moveable between a first position in which the two opposing surfaces form an interface and a second position in which at least one of the two opposing surfaces is deformable to form a clearance for allowing insertion of the container.

18. A utensil holder for holding utensils proximal a container of the type having a longitudinally extending sidewall, the utensil holder comprising:
a first laterally extending, utensil engaging recess configured to engage a first and a second utensil having respective first and second predetermined diameters;
a second laterally extending, utensil engaging recess configured to engage a third and a fourth utensil having respective third and fourth predetermined diameters; and
a longitudinally extending slot defined by opposing surfaces and configured for engaging the sidewall of the container moveable between a first position in which the two opposing surfaces are closely positioned to form an interface and a second position in which at least one of the two opposing surfaces is deformable to form a clearance for allowing insertion of the container.
